(19) United States
(12) Patent Application Publication
(10) Pub. No.: US 2026/0074377 A1
(43) Pub. Date: Mar. 12, 2026

(54) SEPARATOR FOR ELECTROCHEMICAL DEVICE AND ELECTROCHEMICAL DEVICE INCLUDING THE SAME

(71) Applicant: LG ENERGY SOLUTION, LTD., Seoul (KR)

(72) Inventors: Jin Young SHIN, Daejeon (KR); Kyung Ryun KA, Daejeon (KR); In Hyouk SUNG, Daejeon (KR); Hye Won KIM, Daejeon (KR); So Young YOON, Daejeon (KR)

(73) Assignee: LG ENERGY SOLUTION, LTD., Seoul (KR)

(21) Appl. No.: 19/319,349

(22) Filed: Sep. 4, 2025

(30) Foreign Application Priority Data
Sep. 9, 2024 (KR) 10-2024-0122192
Sep. 1, 2025 (KR) 10-2025-0123277

(51) Int. Cl. H01M 50/491; H01M 50/107; H01M 50/417; H01M 50/431; H01M 50/443; H01M 50/446; H01M 50/457

(52) U.S. Cl. CPC H01M 50/491; H01M 50/417; H01M 50/431; H01M 50/443; H01M 50/446; H01M 50/457

(57) ABSTRACT

A separator for an electrochemical device according to one embodiment of the present disclosure includes: a porous polymer substrate; and a coating layer provided on at least one surface of the porous polymer substrate, and including a polymer binder and inorganic particles, in which the porosity of the porous polymer substrate is about 50% to 65%.

### CROSS REFERENCES TO RELATED APPLICATIONS

This application is based on and claims priority from Korean Patent Application No. 10-2024-0122192, filed on Sep. 9, 2024, and No. 10-2025-0123277, filed on Sep. 1, 2025, with the Korean Intellectual Property Office, the disclosure of which is incorporated herein in its entirety by reference.

### TECHNICAL FIELD

The present disclosure relates to a separator for an electrochemical device and the electrochemical device including the same.

### BACKGROUND

An electrochemical device converts chemical energy into electrical energy by using electrochemical reactions. In recent years, lithium secondary batteries, which have a high energy density, a high voltage, and a long cycle life and can be used in various fields, are being used widely.

A lithium secondary battery generates electricity through a chemical reaction in which lithium ions move between a cathode material and an anode material. The lithium ions of the cathode move to the anode while the battery is charged, and the lithium ions of the anode return to the cathode while energy is released and the battery is discharged. Here, there is a need for an electrolyte that acts as a movement passage for lithium ions between the cathode and the anode, and a separator that prevents contact between the cathode and the anode. In general, four components of a lithium ion battery refer to a cathode material, an anode material, an electrolyte, and a separator.

### SUMMARY

The present disclosure provides a separator for an electrochemical device, in which the porosity of a porous polymer substrate is controlled to improve the resistance and at the same time to minimize a thickness variation of the separator.

However, the present disclosure is not limited to the above-mentioned features, and other unmentioned features will be clearly understood by those skilled in the art from the following description.

In one embodiment of the present disclosure, a separator for an electrochemical device is provided. The separator includes: a porous polymer substrate; and a coating layer provided on at least one surface of the porous polymer substrate, and including a polymer binder and inorganic particles, in which the porosity of the porous polymer substrate is about 50% to 65%.

According to one embodiment of the present disclosure, the thickness of the porous polymer substrate may be about 8 μm to 15 μm.

According to one embodiment of the present disclosure, the air permeability of the porous polymer substrate may be about 30 s/100 cc to 90 s/100 cc.

According to one embodiment of the present disclosure, the electrical resistance (ER) of the porous polymer substrate may be about 0.1 ohm to 0.6 ohm.

According to one embodiment of the present disclosure, the coating layer may be provided on both surfaces of the porous polymer substrate.

According to one embodiment of the present disclosure, the thickness of the coating layer may be about 1 μm to 5 μm.

According to one embodiment of the present disclosure, the inorganic particles may contain aluminum hydroxide (Al(OH)₃).

According to one embodiment of the present disclosure, the inorganic particles may contain boehmite.

According to one embodiment of the present disclosure, the inorganic particles may not contain alumina.

According to one embodiment of the present disclosure, a post-compression thickness change rate of the separator may be about 7% or less.

According to one embodiment of the present disclosure, a post-100-cycle thickness change rate of the separator may be about 7% or less.

In one embodiment of the present disclosure, provided is an electrochemical device that includes a cathode; an anode; and any one of the above-described separators, which is interposed between the cathode and the anode.

According to one embodiment of the present disclosure, the electrochemical device may be cylindrical.

In the separator for an electrochemical device according to one embodiment of the present disclosure, the porosity of the porous polymer substrate may be controlled to improve the resistance and at the same time to minimize the thickness variation of the separator.

In the electrochemical device according to one embodiment of the present disclosure, the porosity of the separator may be controlled to improve the resistance and to improve the performance of the electrochemical device.

### BRIEF DESCRIPTION OF THE DRAWINGS

The drawings attached herewith are merely illustrative of embodiments of the present disclosure, and take on the role of further facilitating the understanding of the technical idea of the present disclosure along with the descriptions herein. Thus, the present disclosure should not be construed as being limited to those illustrated in the drawings.

FIG. 1 is a schematic view of a separator for an electrochemical device according to one embodiment of the present disclosure.

FIG. 2 is a view illustrating the structure of the electrochemical device according to one embodiment of the present disclosure.

Corresponding reference characters indicate corresponding components throughout the several views of the drawings, but different reference characters may be given as necessary. The drawing figures presented are illustrated for simplicity and clarity and have not necessarily been drawn to scale. For example, the dimensions of some of the elements in the figures may be exaggerated relative to other elements to help to improve understanding of various embodiments. Also, common but well-understood elements that are useful or necessary in a commercially feasible embodiment are often not depicted in order to facilitate a less obstructed view of these various embodiments.

### DETAILED DESCRIPTION

In this specification, when it is said that a certain part “includes” a certain component, this means that the certain part may further include other components rather than excluding other components unless specifically stated to the contrary.

In this specification, “A and/or B” means “A and B, or A or B”.

In this specification, “about”, “approximately”, and “substantially” are used to mean ranges of numerical values or degrees or approximations thereof, taking into account inherent manufacturing and material tolerances, and are used to prevent infringers from unfairly using the disclosed contents in which precise or absolute figures provided for aiding the understanding of the present disclosure are mentioned.

In this specification, when one component is said to be provided “on” the other component, this does not exclude other components disposed between these, but means that other components may be further disposed unless specifically stated to the contrary.

In this specification, the characteristic of having pores means that the object includes a plurality of pores, and the pores are connected to each other to form a structure that allows gaseous and/or liquid fluid to pass from one side surface to the other side surface of the object.

In this specification, a separator has a porous characteristic including a large number of pores, and serves as a porous ion-conducting barrier that blocks electrical contact between an anode and a cathode in an electrochemical device while allowing ions to pass.

Among the components of an electrochemical device, a separator may include a polymer substrate having a porous structure located between a cathode and an anode. The separator performs a role of preventing an electrical short between the cathode and the anode by separating two electrodes from each other while performing a role of allowing electrolyte and ions to pass therethrough. Although the separator itself does not participate in an electrochemical reaction, physical properties such as wettability to the electrolyte, porosity, and thermal shrinkage may affect the performance and safety of the electrochemical device.

Therefore, in order to enhance these physical properties of the separator, various methods have been attempted, in which a coating layer is added to a porous polymer substrate, and various materials are added to the coating layer so as to improve the properties of the coating layer. As an example, in order to improve the mechanical strength of the separator, inorganic substances may be added to the coating layer, or inorganic substances or hydrates for improving the flame retardancy and heat resistance of the polymer substrate may be added to the coating layer.

Within the coating layer, inorganic particles may be linked to other inorganic particles by a polymer binder to form an interstitial volume, and lithium ions may move through the interstitial volume. For example, the coating layer containing the polymer binder and the inorganic particles performs a role of assisting the movement of lithium ions through the separator while performing a role of preventing thermal shrinkage of the separator.

Meanwhile, in a case where the porosity of the porous polymer substrate used in the separator for an electrochemical device is low, there is a problem in that the rapid charging performance and resistance performance of the electrochemical device may be deteriorated. Accordingly, research is being conducted on methods of increasing the porosity of the porous polymer substrate, thereby lowering the resistance of the electrochemical device.

However, the separator for an electrochemical device, which includes a high-porosity porous polymer substrate, has a disadvantage in that the performance of the electrochemical device is degraded due to a decrease in mechanical strength and an increase in thickness variation of the separator.

Accordingly, under such a situation, there is a need to develop a separator including a high-porosity porous polymer substrate, in which the resistance of the separator may be lowered while the mechanical strength is improved and the thickness variation of the separator is minimized.

Hereinafter, one embodiment of the present disclosure will be described in detail with reference to accompanying drawings. The drawings may be exaggerated, omitted, or schematically illustrated to describe or emphasize the contents of one embodiment of the present disclosure.

Hereinafter, the present disclosure will be described in more detail.

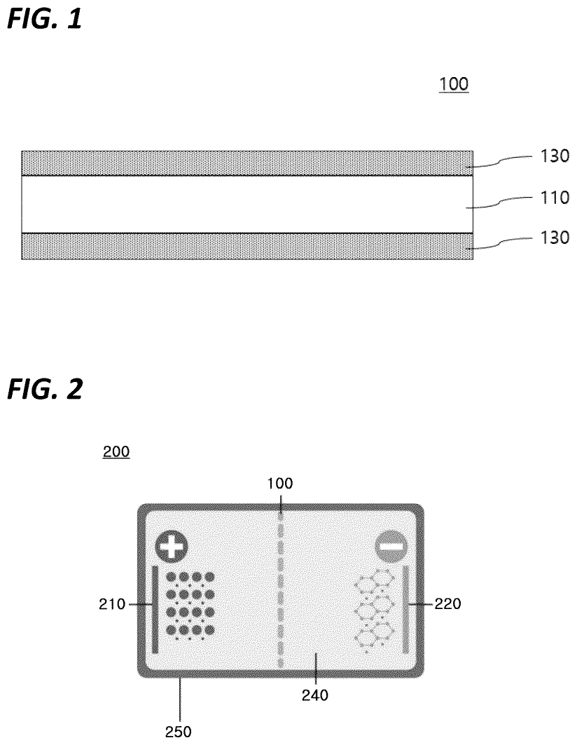

FIG. 1 is a schematic view of a separator for an electrochemical device according to one embodiment of the present disclosure.

In one embodiment of the present disclosure, a separator 100 for an electrochemical device includes: a porous polymer substrate 110; and a coating layer 130 provided on at least one surface of the porous polymer substrate 110 and including a polymer binder and inorganic particles, in which the porosity of the porous polymer substrate 110 is about 50% to 65%. According to one embodiment of the present disclosure, the porosity refers to the ratio of the volume occupied by pores to the volume of the separator, and the porosity may be measured in accordance with ASTM D-2873.

In the separator for an electrochemical device according to one embodiment of the present disclosure, the porosity of the porous polymer substrate may be controlled to improve the resistance and at the same time to minimize a thickness variation of the separator.

The separator 100 for the electrochemical device includes the porous polymer substrate 110. As described above, since the separator 100 for the electrochemical device includes the porous polymer substrate 110, it is possible to allow lithium ions to pass while blocking electrical contact. Then, a shutdown function may be implemented at an appropriate temperature.

According to one embodiment of the present disclosure, the porous polymer substrate 110 may be manufactured using a polyolefin-based resin as a base resin. Examples of the polyolefin-based resin may include polyethylene, polypropylene, and polypentene, and at least one type of these may be included. A porous separator manufactured using this polyolefin-based resin as a base resin, for example, a separator having a large number of pores, may provide a shutdown function at an appropriate temperature.

According to one embodiment of the present disclosure, the weight average molecular weight of the polyolefin-based resin may be about 500,000 to 1,500,000. By adjusting the weight average molecular weight of the polyolefin-based resin within the above range, the compression resistance of the separator may be improved. Furthermore, when a mixture of different types of polyolefin-based resins is used or a separator is formed with a multi-layered structure made of different types of polyolefin-based resins, the weight average molecular weight of the polyolefin-based resin may be calculated by adding up the weight average molecular weights according to the respective content ratios of the polyolefin-based resins.

In this specification, the weight average molecular weight (Mw) may be measured by gel permeation chromatography (GPC, PL GPC220, Agilent Technologies), and the measurement conditions may be set as follows.
Column: PL Olexis (Polymer Laboratories)
Solvent: TCB (Trichlorobenzene)
Flow rate: 1.0 ml/min
Sample concentration: 1.0 mg/ml
Injection volume: 200 μl
Column temperature: 160° C.
Detector: Agilent High Temperature RI detector
Standard: Polystyrene (corrected by a cubic function)

According to one embodiment of the present disclosure, in the method (wet method) of manufacturing the porous polymer substrate 110, a polyolefin-based resin may be mixed with a diluent at high temperatures to form a single phase, and phase-separation between the polymer material and the diluent may be induced in the cooling process, and then the diluent may be extracted to form pores and subsequently, stretching and heat-setting may be performed.

According to one embodiment of the present disclosure, in the manufacturing, the mixing ratio of the diluent, the stretching ratio, the heat-setting temperature, and the like, may be easily controlled by a person skilled in the art so that the average pore size and the maximum pore size of the porous polymer substrate 110 fall within the ranges of the present disclosure.

According to one embodiment of the present disclosure, the porosity of the porous polymer substrate 110 is about 50% to 65%. Within the above-mentioned porosity range, when the electrochemical device is charged and discharged, the performance of the electrochemical device may be maintained while preventing a thickness variation of the separator from being increased due to winding tension. Also, within the above-mentioned porosity range, the ventilation time and electrical resistance (ER) do not increase, and further, an increase in battery internal resistance is suppressed, thereby maintaining the rapid charging performance of the electrochemical device. By controlling the porosity of the porous polymer substrate 110 within the above range, it is possible to minimize the compression and thickness change rate of the separator while improving the resistance.

According to one embodiment of the present disclosure, the thickness of the porous polymer substrate 110 may be about 8 μm to 15 μm. For example, the thickness of the porous polymer substrate 110 may be about 8 μm to 14 μm, about 8 μm to 13 μm, about 8 μm to 12 μm, about 8 μm to 11 μm or about 9 μm to 11 μm, or may be about 10 μm in one embodiment. By controlling the thickness of the porous polymer substrate within the above range, it is possible to improve the energy density of the battery.

According to one embodiment of the present disclosure, the thickness of the porous polymer substrate may be measured by using a thickness measuring device (Mitutoyo corporation, VL-50S-B) through a contact-type measurement method.

According to one embodiment of the present disclosure, the air permeability of the porous polymer substrate 110 may be about 30 s/100 cc to 90 s/100 cc. For example, the air permeability of the porous polymer substrate may be about 30 s/100 cc to 85 s/100 cc, about 30 s/100 cc to 80 s/100 cc, about 30 s/100 cc to 75 s/100 cc, about 30 s/100 cc to 70 s/100 cc, about 35 s/100 cc to 70 s/100 cc or about 40 s/100 cc to 70 s/100 cc. Within the above range of air permeability, a separator thickness change rate may be prevented from increasing due to the compression of the separator, and a resistance increase may be suppressed. By controlling the air permeability of the porous polymer substrate within the above range, it is possible to minimize the compression and thickness change rate of the separator while improving the resistance.

According to one embodiment of the present disclosure, the air permeability (Gurley) may be measured by a method of ASTM D726-94. The Gurley used herein refers to a resistance to air flow and is measured by a Gurley densometer. The air permeability value described herein represents the air permeability time, which is the time (sec) required for 100 cc of air to pass through a cross-section of 1 in² of a sample porous support under a pressure of 12.2 inH₂O.

According to one embodiment of the present disclosure, the electrical resistance (ER) of the porous polymer substrate 110 may be about 0.1 ohm to 0.6 ohm. For example, the electrical resistance (ER) of the porous polymer substrate 110 may be about 0.15 ohm to 0.55 ohm, about 0.2 ohm to 0.55 ohm or about 0.2 ohm to 0.5 ohm. By controlling the electrical resistance (ER) of the porous polymer substrate 110 within the above range, it is possible to improve the separator performance and then the battery performance.

According to one embodiment of the present disclosure, in order to measure the electrical resistance (ER) of the porous polymer substrate, the prepared porous polymer substrate is sufficiently soaked in an electrolyte containing 1 M of LiPF₆ (in ethylene carbonate (EC)/ethyl methyl carbonate (EMC) at a volume ratio of 1:2), and then a coin cell is manufactured by using only such a porous polymer substrate. After the coin cell is left at room temperature for 1 day, the electrical resistance (ER) may be measured by an impedance measurement method.

According to one embodiment of the present disclosure, the coating layer 130 is provided on at least one surface of the porous polymer substrate 110. As described above, since the separator 100 for the electrochemical device includes the coating layer 130 provided on at least one surface of the porous polymer substrate 110, the heat resistance of the separator may be improved, the mechanical properties may be improved, and the separator may be prevented from shrinking at high temperatures and causing an electrical short-circuit in the electrode.

According to one embodiment of the present disclosure, the coating layer 130 includes a polymer binder and inorganic particles. As described above, since the coating layer 130 includes the polymer binder and the inorganic particles, the heat resistance of the separator may be improved, the mechanical properties may be improved, the separator may be prevented or suppressed from shrinking at high temperatures and causing an electrical short-circuit in the electrode, and pores may be formed inside the coating layer.

According to one embodiment of the present disclosure, the coating layer 130 may be formed by the inorganic particles which are bound by polymer binder particles and accumulated within the layer. The pores within the coating layer may be formed by interstitial volumes that are empty spaces between the inorganic particles.

According to one embodiment of the present disclosure, the coating layer 130 may include a plurality of pores. For example, the coating layer 130 may be a porous coating layer. According to one embodiment, the coating layer 130 may be a porous coating layer including a plurality of pores therein. As described above, since the coating layer 130 includes the plurality of pores, lithium ions are allowed to pass and then current is allowed to flow while an anode and a cathode are physically blocked from each other.

According to one embodiment of the present disclosure, the polymer binder in the coating layer 130 may be an acrylic binder and/or a fluorine-based binder. As described above, by selecting the acrylic binder as the polymer binder, the porosity of the separator may be maintained, the adhesive strength between the electrode and the separator may be improved in a lamination process of the battery, thereby improving ease of manufacturing the battery, and the stacking process may be stably implemented. Also, by selecting the fluorine-based binder as the binder particles, the porosity of the separator may be maintained, and then even when the coating layer is wet by the electrolyte after the activation of the battery, the adhesive strength may be maintained. Furthermore, the stiffness of the battery may be improved, and the bending of the battery may be prevented or suppressed.

According to one embodiment of the present disclosure, the fluorine-based binder may be a polyvinylidene-based (PVdF-based) binder. For example, the polyvinylidene-based (PVdF-based) binder may include one or more of a homopolymer of vinylidene fluoride (i.e., polyvinylidene fluoride), a copolymer of vinylidene fluoride and a copolymerizable monomer, and a mixture thereof.

As for the monomer, for example, a fluorinated monomer and/or a chlorinated monomer may be used. Non-limiting examples of the fluorinated monomer may include: vinyl fluoride; trifluoroethylene (TrFE); chlorofluoroethylene (CTFE); 1,2-difluoroethylene; tetrafluoroethylene (TFE); hexafluoropropylene (HFP); perfluoro(methylvinyl) ether (PMVE), perfluoro (alkylvinyl) ether such as perfluoro (ethylvinyl) ether (PEVE) or perfluoro (propylvinyl) ether (PPVE); perfluoro (1,3-dioxole); and perfluoro (2,2-dimethyl-1,3-dioxole) (PDD), and one or more of these may be included.

Also, the polyvinylidene-based (PVdF-based) binder may be a copolymer of polyvinylidene fluoride and hexafluoropropylene. For example, the polyvinylidene-based binder may contain hexafluoropropylene in an amount of about 1 wt % to 50 wt %. As described above, by selecting a polyvinylidene-based binder containing hexafluoropropylene in an amount of about 1 wt % to 50 wt %, as for the polyvinylidene-based binder, the porosity of the separator may be maintained, and then even when the coating layer is wet by the electrolyte after the activation of the battery, the adhesive strength may be maintained.

According to one embodiment of the present disclosure, the acrylic binder may be, for example, polyacrylic acid (PA), polyacrylonitrile (PAN), polyacrylamide (PAA), or (meth)acrylic polymer or a mixture including two or more types of these, but the present disclosure is not limited thereto.

Here, the (meth)acrylic polymer refers to a polymer including (meth)acrylic acid or its ester as a monomer, and examples thereof may include butyl (meth)acrylate, 2-ethylhexyl (meth)acrylate, ethyl (meth)acrylate, methyl (meth)acrylate, n-propyl (meth)acrylate, isopropyl (meth)acrylate, t-butyl (meth)acrylate, pentyl (meth)acrylate, n-octyl (meth)acrylate, isooctyl (meth)acrylate, isononyl (meth)acrylate, lauryl (meth)acrylate, tetradecyl (meth)acrylate, and a mixture of two or more types of these.

Also, the acrylic binder in this specification also includes polyacrylic acid which is a polymer obtained by polymerization using acrylic acid as a monomer. This is a polymer containing carboxylic acid groups as repeating units, and may be understood as an example of the (meth)acrylic polymer of the present disclosure.

Therefore, the polyacrylic acid (PA, e.g., K-702, Lubrizol) used in Examples corresponds to an acrylic binder according to one embodiment of the present disclosure, and is included within the technical scope of the present disclosure, as an example of the polymer including (meth)acrylic acid or a derivative thereof.

According to one embodiment of the present disclosure, the average particle diameter (D50) of the polymer binder is not particularly limited, but may be about 0.1 μm to 1 μm in order to form the coating layer 130 with a uniform thickness and to obtain an appropriate porosity. For example, the average particle diameter (D50) of the polymer binder may be about 0.1 μm to 0.8 μm, about 0.1 μm to 0.6 μm, about 0.1 μm to 0.4 μm, or about 0.1 μm to 0.2 μm. By controlling the average particle diameter (D50) of the polymer binder within the above range, it is possible to improve the dispersibility in a slurry prepared for manufacturing the coating layer, and to reduce the thickness of the formed coating layer.

According to one embodiment of the present disclosure, the content of the polymer binder may be about 1 parts by weight to 10 parts by weight with respect to 100 parts by weight of the coating layer 130. For example, the content of the polymer binder may be about 1 parts by weight to 9 parts by weight, about 1 parts by weight to 8 parts by weight, about 1 parts by weight to 7 parts by weight, about 1 parts by weight to 6 parts by weight, about 1 parts by weight to 5 parts by weight, about 1 parts by weight to 4 parts by weight, or about 2 parts by weight to 4 parts by weight with respect to 100 parts by weight of the coating layer 130. By controlling the content of the polymer binder within the above range, the ease of assembling may be improved in an electrode assembling process.

According to one embodiment of the present disclosure, the inorganic particles may not undergo oxidation and/or reduction reactions in the operating voltage range in the application to the electrochemical device (e.g., 0 V to 5 V based on Li/Li⁺).

According to one embodiment of the present disclosure, the inorganic particle may be at least one selected from BaTiO₃, Pb(Zr,Ti)O₃ (PZT), Pb₁₋ₓLaₓZr_{1-y}Ti_{y}O₃ (PLZT, 0<x<1, 0<y<1), Pb(Mg_{1/3}Nb_{2/3})O₃—PbTiO₃ (PMN-PT), hafnia (HfO₂), SrTiO₃, SnO₂, CeO₂, MgO, Mg(OH)₂, NiO, CaO, ZnO, ZrO₂, SiO₂, Y₂O₃, SiC, Al(OH)₃, TiO₂, zinc tin hydroxide (ZnSn(OH)₆), tin-zinc oxide (Zn₂SnO₄, ZnSnO₃), antimony trioxide (Sb₂O₃), antimony tetroxide (Sb₂O₄), and antimony pentoxide (Sb₂O₅).

According to one embodiment of the present disclosure, the inorganic particles may include aluminum hydroxide (Al(OH)₃). As described above, since the inorganic particles contain aluminum hydroxide (Al(OH)₃), it is possible to ensure the uniformity, the increased surface area and the thermal stability of the coating layer, and further to minimize the separator thickness change rate even if the separator is pressed.

According to one embodiment of the present disclosure, the inorganic particles may include boehmite. For example, the boehmite may be platelet-shaped. According to one embodiment, the platelet boehmite has a two-dimensional structure that is thin and wide-spread, and may be in the form of platelet particles. The platelet boehmite may have a relatively high specific surface area. As described above, since the inorganic particles contain boehmite, it is possible to ensure the uniformity, the increased surface area and the thermal stability of the coating layer, and further to minimize the separator thickness change rate even if the separator is pressed.

According to one embodiment of the present disclosure, the inorganic particles may not include alumina (Al₂O₃). For example, in a case where alumina (Al₂O₃) is included as the inorganic particles, a dense structure with many spherical particles may be generally formed. In contrast, in a case where the boehmite is used, a porous structure is formed in which platelet primary particles are agglomerated. This structure is flexibly deformable when pressed, and micropores in the coating layer act as a buffer, resulting in excellent compression resistance.

Also, since a large number of hydroxyl groups (—OH) are present on the surface of the boehmite, the bonding with the polymer binder or the dispersion stability may be more excellent.

Also, the boehmite may contribute to film thinning by reducing the coating thickness, and may prevent mechanical wear due to its low hardness. In contrast, alumina may cause mechanical wear during a coating process due to its relatively high hardness, and there may be a limit on lowering the coating thickness.

According to one embodiment of the present disclosure, the average particle diameter (D50) of the inorganic particles may be about 0.1 μm to 1 μm. For example, the average particle diameter (D50) of the inorganic particles may be about 0.1 μm to 1 μm, about 0.2 μm to 0.9 μm, about 0.3 μm to 0.8 μm, about 0.4 μm to 0.7 μm or about 0.4 μm to 0.6 μm, or may be about 0.5 μm in one embodiment. By controlling the average particle diameter (D50) of the inorganic particles within the above range, the heat resistance of the coating layer may be secured and the coating uniformity may be achieved.

In this specification, the D50 particle diameter refers to a particle diameter at the point of 50% in the particle diameter-based cumulative distribution of the number of particles. The particle diameter may be measured by using a laser diffraction method. Specifically, measurement target powder is dispersed in a dispersion medium, and then is introduced into a commercially available laser diffraction particle size measurement device (e.g., Microtrac S3500). Then, when the particles pass through laser beam, the particle size distribution is calculated by measuring the difference in the diffraction pattern according to the particle size. The D50 particle diameter may be measured by calculating the particle diameter at the point of 50% in the particle diameter-based cumulative distribution of the number of particles, in the measuring device.

According to one embodiment of the present disclosure, the content of the inorganic particles may be about 90 parts by weight or more and less than 100 parts by weight with respect to 100 parts by weight of the coating layer 130. For example, the content of the inorganic particles may be about 92 parts by weight to 98 parts by weight or about 94 parts by weight to 96 parts by weight with respect to 100 parts by weight of the coating layer 130. By controlling the content of the inorganic particles included in the coating layer 130 within the above range, the heat resistance of the separator may be improved, thereby ensuring the safety of the battery.

According to one embodiment of the present disclosure, the coating layer 130 may be provided on both surfaces of the porous polymer substrate 110. As described above, since the separator 100 for the electrochemical device includes the coating layers 130 provided on both surfaces of the porous polymer substrate 110, the heat resistance of the separator may be improved, and the mechanical properties may be improved. Then, during charging and discharging of the electrochemical device, an increase in separator thickness variation caused by winding tension may be minimized.

According to one embodiment of the present disclosure, the thickness of the coating layer 130 may be about 1 μm to 5 μm. For example, the thickness of the coating layer 130 may be about 1 μm to 4 μm, about 1 μm to 3 μm or about 1.5 μm to 2 μm. Within the above range, an increase in battery internal resistance caused by an increase in separator thickness may be minimized, and the coating uniformity may be secured. By controlling the thickness of the coating layer 130 within the above range, the coating uniformity may be secured, and at the same time an increase in battery internal resistance may be minimized and film thinning may be realized.

In one embodiment of the present disclosure, the thicknesses of the coating layer 130 may be measured by employing a contact-type thickness measuring device. As for the contact-type thickness measuring device, for example, VL-50S-B of Mitutoyo corporation may be used.

According to one embodiment of the present disclosure, the post-compression thickness change rate of the separator may be about 7% or less. For example, the post-compression thickness change rate of the separator may be about 1% to 7%, about 1% to 6.5% or about 3.6% to 6.4%. When the above range is exceeded, the separator thickness change rate may be increased, thereby causing an increase in battery internal resistance.

According to one embodiment of the present disclosure, after 100 cycles, the thickness change rate of the separator may be about 7% or less. For example, the post-100-cycle thickness change rate of the separator may be about 1% to 7%, about 1% to 6.7% or about 4.2% to 6.7%. Within the above range, the separator thickness change rate may be maintained at a minimum, thereby suppressing an increase in battery internal resistance.

Referring to FIG. 2, an electrochemical device 200 according to one embodiment of the present disclosure includes: a cathode 210; an anode 220; and the above-described separator 100 based on one embodiment of the present disclosure and interposed between the cathode and the anode. Also, the electrochemical device 200 according to one embodiment of the present disclosure may further include an electrolyte 240 and a battery case 250. In the electrochemical device 200 according to one embodiment of the present disclosure, the contents overlapping with the description for the separator 100 for the electrochemical device will be omitted.

In the electrochemical device 200 according to one embodiment of the present disclosure, the porosity of the separator 100 may be adjusted to improve the resistance and to improve the electrochemical device performance.

In one embodiment of the present disclosure, the electrochemical device 200 is a device that converts chemical energy into electrical energy through an electrochemical reaction, and has a concept that encompasses a primary battery and a secondary battery. In this specification, the secondary battery is chargeable and dischargeable, and refers to a lithium secondary battery, a nickel-cadmium battery, or a nickel-hydrogen battery. The lithium secondary battery uses lithium ions as an ion conductor. Examples thereof may include a non-aqueous electrolyte secondary battery including a liquid electrolyte, a solid-state battery including a solid electrolyte, a lithium polymer battery including a gel polymer electrolyte, and a lithium metal battery using a lithium metal as an anode, but are not limited to these.

According to one embodiment of the present disclosure, the cathode 210 includes: a cathode current collector; and a cathode active material layer including a cathode active material, a conductive material and a binder resin, on at least one surface of the current collector. The cathode active material may include one type or a mixture of two or more types among layered compounds such as lithium manganese composite oxide (LiMn₂O₄, LiMnO₂, etc.), lithium cobalt oxide (LiCoO₂), and lithium nickel oxide (LiNiO₂) or compounds substituted with one or more transition metals; lithium manganese oxide such as chemical formulas Li₁₊ₓMn₂₋ₓO₄ (where x is 0 to 0.33), LiMnO₃, LiMn₂O₃, and LiMnO₂; lithium copper oxide (Li₂CuO₂); vanadium oxide such as LiV₃O₈, LiV₃O₄, V₂O₅, and Cu₂V₂O₇; Ni site-type lithium nickel oxide represented by a chemical formula LiNi₁₋ₓMₓO₂ (where M=Co, Mn, Al, Cu, Fe, Mg, B or Ga, and x=0.01 to 0.3); lithium manganese composite oxide represented by a chemical formula LiMn₁₋ₓMₓO₂ (where M=Co, Ni, Fe, Cr, Zn or Ta, and x=0.01 to 0.1) or Li₂Mn₃MO₈ (where M=Fe, Co, Ni, Cu or Zn); LiMn₂O₄ in which a part of Li in the chemical formula is substituted with an alkaline earth metal ion; a disulfide compound; and Fe₂(MoO₄)₃.

According to one embodiment of the present disclosure, the anode 220 includes: an anode current collector; and an anode active material layer including an anode active material, a conductive material and a binder resin, on at least one surface of the current collector. The anode may include, as for the anode active material, one type or a mixture of two or more types selected from lithium metal oxides; carbon such as non-graphitizable carbon, or graphite-based carbon; metal composite oxides such as LixFe₂O₃ (0≤x≤1), LiₓWO₂ (0≤x≤1), and SnₓMe₁₋ₓMe′_{y}O_{z} (Me: Mn, Fe, Pb, Ge; Me′: Al, B, P, Si, elements of groups 1, 2, and 3 of the periodic table, halogen; 0<x≤1; 1≤y≤3; 1≤z≤8); lithium metal; lithium alloys; silicon-based alloys; tin-based alloys; metal oxides such as SnO, SnO₂, PbO, PbO₂, Pb₂O₃, Pb₃O₄, Sb₂O₃, Sb₂O₄, Sb₂O₅, GeO, GeO₂, Bi₂O₃, Bi₂O₄, and Bi₂O₅; conductive polymers such as polyacetylene; Li—Co—Ni-based materials; and titanium oxide.

According to one embodiment of the present disclosure, the conductive material may be any one selected from, for example, graphite, carbon black, carbon fiber or metal fiber, metal powder, conductive whiskers, conductive metal oxide, activated carbon and polyphenylene derivatives, or a mixture of two or more types of conductive materials of these. According to one embodiment, the conductive material may be one type selected from natural graphite, artificial graphite, super-p, acetylene black, Ketjen black, channel black, furnace black, lamp black, thermal black, Denka black, aluminum powder, nickel powder, zinc oxide, potassium titanate and titanium oxide, or a mixture of two or more types of conductive materials of these.

According to one embodiment of the present disclosure, the current collector is not particularly limited as long as it has high conductivity without causing chemical changes in the corresponding battery. For example, stainless steel, copper, aluminum, nickel, titanium, calcined carbon, or aluminum or stainless steel whose surface is treated with carbon, nickel, titanium, or silver may be used.

According to one embodiment of the present disclosure, as for the binder resin, a polymer commonly used for electrodes in the art may be used. Non-limiting examples of this binder resin may include polyvinylidene fluoride-co-hexafluoropropylene, polyvinylidene fluoride-co-trichloroethylene, polymethylmethacrylate, polyetylhexyl acrylate, polybutyl acrylate, polyacrylonitrile, polyvinylpyrrolidone, polyvinyl acetate, polyethylene-co-vinyl acetate, polyethylene oxide, polyarylate, cellulose acetate, cellulose acetate butyrate, cellulose acetate propionate, cyanoethyl pullulan, cyanoethyl polyvinyl alcohol, cyanoethyl cellulose, cyanoethyl sucrose, pullulan and carboxyl methyl cellulose, and are not limited to these.

According to one embodiment of the present disclosure, a cathode slurry for producing the cathode active material layer may contain a dispersant. The dispersant may be a pyrrolidone-based compound, and specifically, may be N-methylpyrrolidone (ADC-01, LG chemical).

According to one embodiment of the present disclosure, the electrolyte 240 of the electrochemical device 200 includes a salt having a structure such as A⁺B⁻, which may be dissolved or dissociated in an organic solvent, but the present disclosure is not limited thereto. A⁺ may include alkali metal cations such as Li⁺, Na⁺, and K⁺ or ions composed of combinations thereof. Also, B⁻ may include anions such as PF₆⁻, BF₄⁻, Cl⁻, Br⁻, I⁻, ClO₄⁻, AsF₆⁻, CH₃CO₂, CF₃SO₃⁻, N(CF₃SO₂)₂⁻, and C(CF₂SO₂)₃⁻ or ions composed of combinations thereof. The organic solvent includes propylene carbonate (PC), ethylene carbonate (EC), diethyl carbonate (DEC), dimethyl carbonate (DMC), dipropyl carbonate (DPC), dimethyl sulfoxide, acetonitrile, dimethoxyethane, diethoxyethane, tetrahydrofuran, N-methyl-2-pyrrolidone (NMP), ethyl methyl carbonate (EMC), gamma butyrolactone or a mixture thereof.

According to one embodiment of the present disclosure, the electrochemical device 200 may be cylindrical.

For example, the separator 100 according to one embodiment of the present disclosure may be suitable for the cylindrical electrochemical device 200 because film thinning is realized by selecting boehmite for the coating layer.

Also, in the separator 100 according to one embodiment of the present disclosure, by selecting boehmite for the coating layer, it is possible to minimize the separator thickness variation caused by winding tension during charging/discharging.

As described above, as for the electrochemical device 200, a cylindrical one may be selected, so that it is possible to contribute to the film thinning and at the same time to minimize the separator thickness variation caused by winding tension.

According to one embodiment of the present disclosure, a battery module including a battery including the electrochemical device 200 as a unit cell, a battery pack including the battery module, and a device including the battery pack as a power source may be provided. Examples of the device may include: a power tool powered and driven by an electric motor; electric cars including an electric vehicle (EV), a hybrid electric vehicle (HEV), a plug-in hybrid electric vehicle (PHEV), etc.; electric two-wheeled vehicles including an electric bicycle (E-bike), and an electric scooter (E-scooter); an electric golf cart; and a power storage system, but are not limited thereto.

Hereinafter, the present disclosure will be described in detail with reference to examples. However, Examples according to the present disclosure may be modified in various different forms, and the scope of the present disclosure is not construed as being limited to Examples described below. Examples of the present specification are provided to more completely illustrate the present disclosure, to those having average knowledge in the art.

### Example 1

### Manufacturing of Porous Polymer Substrate

A porous polymer substrate was manufactured by extruding polyethylene resin (weight average molecular weight 1,000,000) through a wet method. The total thickness of the manufactured porous polymer substrate was about 10 μm, the porosity was 55%, the air permeability was 60 s/100 cc, and the resistance (ER) was 0.4 (2.

As described above, in the manufacturing, the mixing ratio of the diluent, the stretching ratio, the heat-setting temperature, etc. may be easily controlled by a person skilled in the art so that the average pore size and the maximum pore size of the porous polymer substrate fall within the ranges of the present disclosure.

### Formation of Coating Layer

Boehmite with a D50 particle diameter of 500 nm was prepared as an inorganic particle. Polyacrylic acid (K-702, Lubrizol) with a D50 particle diameter of 200 nm was prepared as a polymer binder, sodium carboxymethyl cellulose (CMC-Na) (SG-L02, GL Chem) was prepared as a dispersant, and a silicone surfactant (BYK-348, BYK) was prepared.

The prepared inorganic particles, the polymer binder, the dispersant and the surfactant were added to water at a weight ratio of 95:4:0.5:0.5 and then were dispersed to prepare a slurry for a coating layer.

The coating layer slurry was applied to both surfaces of the porous polymer substrate by a bar-coating method using a doctor blade, and was dried in wind at 50° C. by using a heat gun so that a coating layer was formed with a thickness of 1.5 μm on each of the two surfaces of the porous polymer substrate.

### Example 2

A separator was prepared in the same manner as in Example 1 except that the thickness of each coating layer in Example 1 was 2.0 μm.

### Example 3

A separator was prepared in the same manner as in Example 1 except that the porosity of the porous polymer substrate manufactured in Example 1 was 50%.

### Example 4

A separator was prepared in the same manner as in Example 1 except that the porosity of the porous polymer substrate manufactured in Example 1 was 60%.

### Example 5

A separator was prepared in the same manner as in Example 1 except that the porosity of the porous polymer substrate manufactured in Example 1 was 65%.

In all Examples 1 to 5, boehmite with a D50 particle diameter of 500 nm was prepared as an inorganic particle for forming a coating layer, and coating layers were formed on both surfaces of a porous polymer substrate. In addition, in each Example, the manufacturing was performed by changing the porosity of the porous substrate and the thickness of the coating layer.

### Comparative Example 1

### Manufacturing of Porous Polymer Substrate

A porous polymer substrate was manufactured by extruding polyethylene resin (weight average molecular weight 1,000,000) through a wet method. The total thickness of the manufactured porous polymer substrate was about 10 μm, the porosity was 55%, the air permeability was 60 s/100 cc, and the resistance (ER) was 0.4Ω.

As described above, in the manufacturing, the mixing ratio of the diluent, the stretching ratio, and the heat-setting temperature may be easily controlled by a person skilled in the art so that the average pore size and the maximum pore size of the porous polymer substrate fall within the ranges of the present disclosure.

### Formation of Coating Layer

Al₂O₃ (AES 11, Sumitomo Corporation) with a D50 particle diameter of 500 nm was prepared as an inorganic particle. Polyacrylic acid (K-702, Lubrizol) with a D50 particle diameter of 200 nm was prepared as a polymer binder, sodium carboxymethyl cellulose (CMC-Na) (SG-L02, GL Chem) was prepared as a dispersant, and a silicone surfactant (BYK-348, BYK) was prepared.

The prepared inorganic particles, the polymer binder, the dispersant and the surfactant were added to water at a weight ratio of 95:4:0.5:0.5, and then were dispersed to prepare a slurry for a coating layer.

The coating layer slurry was applied to one surface of the porous polymer substrate by a bar-coating method using a doctor blade, and was dried in wind at 50° C. by using a heat gun so that a coating layer was formed with a thickness of 2.0 μm.

### Comparative Example 2

A separator was prepared in the same manner as in Comparative Example 1 except that the thickness of the coating layer in Comparative Example 1 was 3.0 μm.

### Comparative Example 3

A separator was prepared in the same manner as in Comparative Example 1 except that boehmite with a D50 particle diameter of 500 nm was used as the inorganic particle in Comparative Example 1.

### Comparative Example 4

A separator was prepared in the same manner as in Comparative Example 3 except that the thickness of the coating layer in Comparative Example 3 was 3.0 μm.

### Comparative Example 5

A separator was prepared in the same manner as in Comparative Example 1 except that the coating layer in Comparative Example 1 was formed with a thickness of 1.0 μm on each of the two surfaces of the porous polymer substrate.

### Comparative Example 6

A separator was prepared in the same manner as in Comparative Example 5 except that the thickness of each coating layer in Comparative Example 5 was 1.5 μm.

### Comparative Example 7

A separator was prepared in the same manner as in Example 1 except that the thickness of each coating layer in Example 1 was 1.0 μm.

### Comparative Example 8

A separator was prepared in the same manner as in Example 1 except that the porosity of the porous polymer substrate in Example 1 was 40%.

### Comparative Example 9

A separator was prepared in the same manner as in Example 1 except that the porosity of the porous polymer substrate in Example 1 was 45%.

In some of Comparative Examples 1 to 9, alumina (Al₂O₃) with a D50 particle diameter of 500 nm was prepared as an inorganic particle for forming a coating layer (Comparative Examples 1, 2, 5, and 6), and in other Comparative Examples, boehmite was prepared (Comparative Examples 3, 4, 7, 8, and 9). Also, in some Comparative Examples, a coating layer was formed on a single surface of the porous polymer substrate (Comparative Examples 1, 2, 3, and 4), and in other Comparative Examples, coating layers were formed on both surfaces (Comparative Examples 5, 6, 7, 8, and 9).

### <Manufacturing of Cylindrical Electrochemical Device>

A cylindrical electrochemical device was manufactured by using a separator for an electrochemical device in each of Examples and Comparative Examples.

### 1) Manufacturing of Cathode

A cathode active material (LiNi_{0.8}Mn_{0.1}Co_{0.1}O₂), a conductive material (carbon black), a dispersant (N-methylpyrrolidone, ADC-01, LG chemical) and a binder resin (a mixture of PVDF-HFP and PVDF) were mixed with water at a weight ratio of 97.5:0.7:0.14:1.66 to prepare a slurry for a cathode active material layer in which the concentration of the remaining components excluding water was 50 wt %. Next, the slurry was applied to the surface of an aluminum thin film (thickness of 10 μm) and was dried to manufacture a cathode having a cathode active material layer (thickness of 120 μm).

### 2) Manufacturing of Anode

Graphite (a blend of natural graphite and artificial graphite), a conductive material (carbon black), a dispersant (Polyvinylpyrrolidone, Junsei, Japan) and a binder resin (a mixture of PVDF-HFP and PVDF) were mixed with water at a weight ratio of 97.5:0.7:0.14:1.66 to prepare a slurry for an anode active material layer in which the concentration of the remaining components excluding water was 50 wt %. Next, the slurry was applied to the surface of a copper thin film (thickness of 10 μm) and was dried to manufacture an anode having an anode active material layer (thickness of 120 μm).

### 3) Manufacturing of Cylindrical Electrochemical Device

The separator in Examples and Comparative Examples was interposed between the manufactured anode and cathode and stacking was performed in the order of ‘separator-anode-separator-cathode’ to form an electrode assembly.

The electrode assembly stack was wound into a jelly roll shape to manufacture a cylindrical electrochemical device.

### Experimental Example

### Measurement of Air Permeability of Separator

The air permeability time (air permeability, Gurley) of the separator in Examples and Comparative Examples was measured by a method of ASTM D726-94. The Gurley used herein is a resistance to air flow and is measured by a Gurley densometer. The air permeability value described herein represents the time (sec) required for 100 cc of air to pass through a cross-section of 1 in² of the separator under a pressure of 12.2 inH₂O, that is, the air permeability time.

### Measurement of Resistance of Separator

For the resistance of the separator of Examples and Comparative Examples, each separator substrate was interposed between SUS plates, and the electrolyte was injected to manufacture a coin cell, and then the resistance (ER) was measured by an EIS method. Here, the frequency falls within a range of 100,000 to 10,000 Hz. The electrolyte was obtained by mixing LiPF₆ with a non-aqueous solvent at a concentration of 1 M. In the non-aqueous solvent, ethylene carbonate (EC) and ethyl methyl carbonate (EMC) were mixed at a ratio of 3:7.

### Measurement of Post-Compression Thickness Change Rate

The post-compression thickness change rate of the separator in Examples and Comparative Examples was measured by the following method.

First, after a separator sample (width 2 cm×length 2 cm) was prepared, the initial thickness (Tₒ) was measured using a micrometer at room temperature. Then, compression was performed by applying a pressure of about 3 MPa to the separator sample for 5 min. The thickness (T₁) of the separator was measured again immediately after the pressure was removed after compression.

Here, the post-compression thickness change rate of the separator was calculated in accordance with the following equation:

Thickness change rate (%)=(T₁−T₀/T₀)×100

Through this, the degree of separator thickness variation caused by mechanical compression was measured, and the degrees are noted in Tables 1 and 2 below.

### Measurement of Post-100-Cycle Thickness Change Rate

After the charging/discharging cycle of the separator of Examples and Comparative Examples, the thickness change rate (%) of the separator was measured by the following method.

A coin cell was assembled using the separator of the present disclosure, and then, immediately after the cell was assembled, the thickness (Tₒ) of the separator was measured. Next, the battery was subjected to 100 charging/discharging cycles within a voltage range of 2.5 to 4.2 V at a current density of 0.5 C in an environment of 25° C. After the completion of the cycles, the thickness (T₁) of the separator was measured.

Here, the post-100-cycle thickness change rate (%) of the separator was calculated in accordance with the following equation:

Thickness change rate (%)=(T₁−T₀/T₀)×100

Through this, the separator thickness change rate (%) was measured by comparing the separator thicknesses measured before and after 100 cycles, and these rates are noted in Tables 1 and 2 below.

### Evaluation of Direct Current Internal Resistance (DCIR) of Electrochemical Device

The electrochemical device of Examples and Comparative Examples was charged through an application of current of 2.5 C until SOC of 50% was reached. In a state where each electrochemical device reached SOC of 50%, the DCIR resistance values were calculated in accordance with the following equation 1, and are noted in Tables 1 and 2 below.

DCIR=(V0−V1)/I (V0=voltage before pulse, V1=voltage 10 seconds after pulse, I=applied current) [Eq. 1]

TABLE 1

| | Exam- | Exam- | Exam- | Exam- | Exam- |
|---|---|---|---|---|---|
| | ple 1 | ple 2 | ple 3 | ple 4 | ple 5 |
| Type of inorganic | Boehm- | Boehm- | Boehm- | Boehm- | Boehm- |
| substances | ite | ite | ite | ite | ite |
| Coating layer thickness | 1.5 | 2 | 1.5 | 1.5 | 1.5 |
| (μm) | | | | | |
| One/both surfaces of | Both | Both | Both | Both | Both |
| coating layer | | | | | |
| Separator thickness (μm) | 13 | 14 | 13 | 13 | 13 |
| Porosity (%) | 55 | 55 | 50 | 60 | 65 |
| Air permeability | 60 | 60 | 66 | 49 | 43 |
| (s/100 cc) | | | | | |
| ER (Ω) | 0.4 | 0.4 | 0.5 | 0.3 | 0.2 |
| Post-compression | 4.2 | 3.6 | 3.7 | 5.4 | 6.4 |
| thickness change rate (%) | | | | | |
| Post-100-cycle | 4.5 | 4.2 | 4.2 | 5.9 | 6.7 |
| thickness change rate (%) | | | | | |
| DCIR (Ω) | 1.205 | 1.249 | 1.265 | 1.144 | 1.116 |

TABLE 2

| | Comp. | Comp. | Comp. | Comp. | Comp. | Comp. | Comp. | Comp. | Comp. |
|---|---|---|---|---|---|---|---|---|---|
| | Example | Example | Example | Example | Example | Example | Example | Example | Example |
| | 1 | 2 | 3 | 4 | 5 | 6 | 7 | 8 | 9 |
| Type of | Alumina | Alumina | Boehmite | Boehmite | Alumina | Alumina | Boehmite | Boehmite | Boehmite |
| inorganic | | | | | | | | | |
| substances | | | | | | | | | |
| Coating | 2 | 3 | 2 | 3 | 1 | 1.5 | 1 | 1.5 | 1.5 |
| layer | | | | | | | | | |
| thickness | | | | | | | | | |
| (μm) | | | | | | | | | |
| One/both | One | One | One | One | Both | Both | Both | Both | Both |
| surfaces | | | | | | | | | |
| of | | | | | | | | | |
| coating | | | | | | | | | |
| layer | | | | | | | | | |
| Separator | 12 | 13 | 12 | 13 | 12 | 13 | 12 | 13 | 13 |
| thickness | | | | | | | | | |
| (μm) | | | | | | | | | |
| Porosity | 55 | 55 | 55 | 55 | 55 | 55 | 55 | 40 | 45 |
| (%) | | | | | | | | | |
| Air | 60 | 60 | 60 | 60 | 60 | 60 | 60 | 115 | 100 |
| permeability | | | | | | | | | |
| s/100 cc) | | | | | | | | | |
| ER (Ω) | 0.4 | 0.4 | 0.4 | 0.4 | 0.4 | 0.4 | 0.4 | 0.68 | 0.62 |
| Post- | 8.6 | 7.9 | 7.1 | 6.8 | Unable | 6.5 | Unable | 3.2 | 3.5 |
| compression | | | | | to | | to | | |
| thickness | | | | | secure | | secure | | |
| change | | | | | coating | | coating | | |
| rate (%) | | | | | uniformity | | uniformity | | |
| Post-100- | 9.4 | 9.1 | 8.4 | 7.7 | | 7.4 | | 3.7 | 4.1 |
| cycle | | | | | | | | | |
| thickness | | | | | | | | | |
| change | | | | | | | | | |
| rate (%) | | | | | | | | | |
| DCIR | 1.295 | 1.313 | 1.246 | 1.265 | | 1.303 | | 1.372 | 1.344 |
| (Ω) | | | | | | | | | |

According to Table 1, in Examples 1 to 5, the porosity of the porous polymer substrate was increased from 30% to 40% (a conventional range) to 50% to 65% so as to improve the resistance of the separator and at the same time to minimize the compression and thickness change rate of the separator. For example, the resistance (ER) of the separator in Examples 1 to 5 was at the level of 0.2 (2 to 0.5Ω, the post-compression thickness change rate of the separator was at the level of 3.6% to 6.4%, and the post-100-cycle thickness change rate of the separator was at the level of 4.2% to 6.7%.

In contrast, according to Table 2, in Comparative Examples 1 to 4, it can be found that since the coating layer was applied to a single surface, the post-compression thickness change rate and the post-100-cycle thickness change rate were increased. For example, in Comparative Examples 1 to 4, the post-compression thickness change rate of the separator was at the level of 6.8% to 8.6%, and the post-100-cycle thickness change rate of the separator was at the level of 7.7% to 9.4%.

In Comparative Examples 1 and 2 and Comparative Examples 3 and 4, among single-surface coatings, it can be found that as the coating layer thickness increases, the battery internal resistance (DCIR) increases. For example, in the case of Comparative Examples 1 and 2, the coating layer thicknesses were 2 μm and 3 μm, respectively, and the battery internal resistance values (DCIR) were 1.295 (2 and 1,313Ω, respectively.

In Comparative Examples 5 and 7, although the coating layers were formed on both surfaces of the porous polymer substrate, when the coating layer thickness of each surface was relatively thin (1 μm), there was a problem in that it was difficult to secure coating uniformity.

In Comparative Example 6, when, instead of boehmite, alumina was used as inorganic substances in the coating layer, the post-compression thickness change rate of the separator was 6.5% and the post-100-cycle thickness change rate of the separator was 7.4%, and then it can be found that compared to Examples, the post-100-cycle thickness change rate of the separator was increased. Accordingly, it can be found that the use of boehmite is more advantageous in the compression resistance of the separator.

In Comparative Examples 8 and 9, it can be found that the porosities of the porous polymer substrates were relatively low (40% and 45%, respectively) and the ventilation times were increased, and then compared to Examples and other Comparative Examples, the electrical resistance values (ER) were increased to 0.68Ω and 0.62Ω, respectively, and moreover, the battery internal resistance values were increased to 1.372 (2 and 1.344Ω, respectively.

Therefore, in the separator for an electrochemical device according to one embodiment of the present disclosure and the electrochemical device including the same, the porosity of the porous polymer substrate may be controlled and the material for the coating layer may be appropriately selected so as to improve the resistance and at the same time to minimize the compression and thickness change rate of the separator.

Although the above descriptions have been made with reference to embodiments of the present disclosure, it will be understood by those of ordinary skill in the art in the relevant technical field or those having ordinary knowledge in the relevant technical field that various modifications and changes can be made to various embodiments of the present disclosure within a scope that does not depart from the technical scope of various embodiments of the present disclosure described in the claims to be described below. Therefore, the technical scope of various embodiments of the present disclosure should not be limited to the contents described in the detailed description of the specification, but should be determined by the claims.

### DESCRIPTION OF SYMBOLS

100: separator for electrochemical device
110: porous polymer substrate
130: coating layer
200: electrochemical device
210: cathode
220: anode
240: electrolyte
250: battery case

What is claimed is:

1. A separator for an electrochemical device, the separator comprising:
a porous polymer substrate; and
a coating layer provided on at least one surface of the porous polymer substrate, and including a polymer binder and inorganic particles,
wherein the porosity of the porous polymer substrate is 50% to 65%.

2. The separator for an electrochemical device according to claim 1, wherein the thickness of the porous polymer substrate is 8 μm to 15 μm.

3. The separator for an electrochemical device according to claim 1, wherein the air permeability of the porous polymer substrate is 30 s/100 cc to 90 s/100 cc.

4. The separator for an electrochemical device according to claim 1, wherein the electrical resistance (ER) of the porous polymer substrate is 0.1 ohm to 0.6 ohm.

5. The separator for an electrochemical device according to claim 1, wherein the coating layer is provided on both surfaces of the porous polymer substrate.

6. The separator for an electrochemical device according to claim 1, wherein the thickness of the coating layer is 1 μm to 5 μm.

7. The separator for an electrochemical device according to claim 1, wherein the inorganic particles contains aluminum hydroxide (Al(OH)₃).

8. The separator for an electrochemical device according to claim 1, wherein the inorganic particles used for the coating layer contains boehmite.

9. The separator for an electrochemical device according to claim 7, wherein the inorganic particles do not contain alumina.

10. The separator for an electrochemical device according to claim 1, wherein a post-compression thickness change rate of the separator is 7% or less.

11. The separator for an electrochemical device according to claim 1, wherein a post-100-cycle thickness change rate of the separator is 7% or less.

12. An electrochemical device comprising:
a cathode;
an anode; and
the separator according to claim 1 interposed between the cathode and the anode.

13. The electrochemical device according to claim 12, wherein the electrochemical device is cylindrical.
